(19) United States
(12) Patent Application Publication
(10) Pub. No.: US 2012/0074765 A1
(43) Pub. Date: Mar. 29, 2012

(54) Plastic wheels

(76) Inventor: Edgar Guzman, Los Angeles, CA (US)

(21) Appl. No.: 12/800,465

(22) Filed: Sep. 27, 2010

(51) Int. Cl. B60B 21/00; C08L 33/06

(52) U.S. Cl. 301/95.101; 525/55

(57) ABSTRACT

The present invention provides a set of tire rims designed specifically with affordability in mind. Similar in appearance and structure to a set of standard tire rims, the Appache Rims are produced in a variety of sizes and designs for use with the many makes and models vehicles on the road. As with standard tire rims, the Appache Rims are secured in place on the vehicle via threaded bolts. The rims of the present invention are comprised of heavy duty plastic and acrylic material. The Appache Rims are extremely hard, mimicking the structure of traditional chrome rims. Further, the Appache Rims can be coated in a thin layer of faux or real polished chrome, alloy or silver, thus creating the effect of costly, high-end rims.

### FIELD OF THE INVENTION

The present invention pertains to the field of automotive accessories, and more specifically to the field of low cost, decorative wheels for an automobile.

### BACKGROUND OF THE INVENTION

The prior art has put forth several designs for low cost decorative wheels. Among these are:

U.S. Pat. No. 5,234,260 to Coombes, Jr., describes a hubcap assembly comprising an annular anchor adapted to be fixedly mounted on the outer surface of an automobile wheel.

U.S. Pat. No. 4,027,919 to Foster describes a wheel cover formed of plastic or metal having a wire ring supported on the inboard face thereof.

U.S. Pat. No. 4, 457,560 to Rowe et al describes a hubcap with improved retention structure comprising an outer plastic hubcap element and an inner metal retention element.

None of these prior art references describe the present invention.

### SUMMARY OF THE INVENTION

It is an object of the present invention to provide an improved stylish tire rim that is attractive and affordable comprising heavy duty plastic and acrylic material.

### BRIEF DESCRIPTION OF THE DRAWING

FIG. 1 is a perspective view of the tire rim of the present invention.

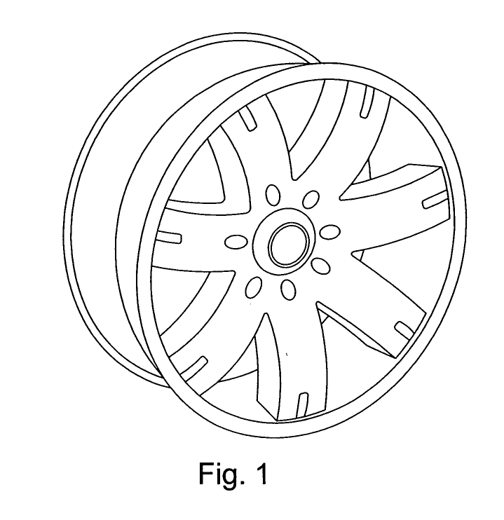

### DETAILED DESCRIPTION OF THE INVENTION

Many Americans enjoy an interest in customizing their automobiles. Whether by ordering personalized license plates, attaching fancy mud flaps to the rear tires, installing floating neon lights along the car's undercarriage or airbrushing elaborate designs upon the car's hood and trunk, customizing one's vehicle is truly an exciting and artistic way in which to express oneself.

An extremely popular way in which people revamp the overall appearance of their cars, trucks, and vans, is by installing a new set of tires. Produced in a variety of styles, such as mag wheels, low profile, whitewashed and modular, a new set of tires can vastly improve the appearance of any auto. Although most car enthusiasts would agree that “the right” tires are a crucial element to the overall design of their automobile, it is common knowledge that a set of high-polished rims can add the perfect finishing touch.

Like tires, rims are manufactured in a wide variety of styles and materials. Shiny chrome, gold plated or polished aluminum, for example. Rims are an attractive accessory that most automobile afficionados recognize as an important design element. While rims are produced in a variety of styles, manufacturers such as Prime, Eagle Alloys, Primax, Konig and ADR are continually developing new, exciting designs to entice customers and satisfy the many needs of car enthusiasts.

While there is little dispute that a set of polished rims provides consumers a striking means of customizing their vehicles, actually purchasing a set of tire rims can be a costly endeavor. Ranging in price from several hundred to several thousand dollars for a complete set, purchasing brand name tire rims is simply not an option for many consumers.

Recognizing the potential for an affordable new rim design, the present invention, hereinafter referred to Appache Rims, was developed. The Appache Rims is a set of tire rims designed specifically with affordability in mind. Similar in appearance and structure to a set of standard tire rims, the Appache Rims are produced in a variety of sizes and designs for use with the many makes and models vehicles on the road. As with standard tire rims, the Appache Rims are secured in place on the vehicle via threaded bolts.

One novel aspect of the Appache Rims is that these covers are manufactured of heavy duty plastic and acrylic material. The Appache Rims are extremely hard, mimicking the structure of traditional chrome rims. Further, the Appache Rims can be coated in a thin layer of faux or real polished chrome, alloy or silver, thus creating the effect of costly, high-end rims.

Use of Appache Rims is very simple and straight forward. First, the consumer purchases a set of covers in accordance to the make and model of their vehicle. By way of example, if one wished to adorn a red, 1962 Ferrari 250 GTO, Appache Rims brilliantly polished “silver” rims would be very attractive. Similarly, an owner of a silver, 1997 GMC Sonoma Lowrider might enjoy rims featuring a multi-spoke design. The consumer then has the Appache Rims professionally installed on their vehicle by a mechanic or service technician, or in the case of the skilled auto lover, they would simply install the rims themselves.

There are many benefits and advantages associated with Appache Rims. Foremost, the Appache Rims provide consumers an affordable means of customizing their car with stylish rims. Extremely reasonable in price, the Appache Rims enable consumers to apply striking, expensive looking rims to their car, without spending a fortune. These rims can be very easily manufactured, thus the Appache Rims can be mass produced, while creating jobs and industry in the United States. Transforming an ordinary automobile into a dazzling showpiece, the Appache Rims offer car enthusiasts an attractive means of improving the appearance of their car. Auto lovers who collect vintage classics or who enjoy restoring newer cars will especially appreciate these striking rim designs. Fully functional, tires would run smoothly and efficiently on Appache Rims.

The Appache Rims is a cleverly designed invention which offers the car enthusiasts a cost-effective means of turning standard tires into attractive and fancy pieces of art. Easy to install, these affordable coverings almost instantly transform the appearance of any car or truck.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. Decorative rims for automobile tires, comprising heavy duty plastic and acrylic material.

2. The rims of claim 1 further comprising a thin layer of faux or real polished chrome, alloy or silver.
